(19) United States
(12) Patent Application Publication
(10) Pub. No.: US 2015/0068630 A1
(43) Pub. Date: Mar. 12, 2015

(54) OXYGEN/AIR SUPPLY FOR FUEL CELL APPLICATIONS

(71) Applicant: Avox Systems, Inc., Lancaster, NY (US)

(72) Inventors: Jean-Paul Libis, Bievres (FR); Jerome Cerisier, Meudon (FR); Vincent Gillotin, Vauhallan (FR); Yannick Brunaux, Saint Cyr L'ecole (FR)

(21) Appl. No.: 14/390,196

(22) PCT Filed: Mar. 13, 2013
(86) PCT No.: PCT/US2013/030634

§ 371 Date: Oct. 2, 2014

Related U.S. Application Data
(60) Provisional application No. 61/620,517, filed on Apr. 5, 2012.

(51) Int. Cl. B64D 33/00; H01M 8/04

(52) U.S. Cl. CPC B64D 33/00; H01M 8/04201; H01M 2250/20
USPC 137/899

(57) ABSTRACT

Embodiments of the present invention relate generally to oxygen/air supply systems and methods for use with fuel cell system applications on-board passenger transportation vehicles, such as aircraft or other aerospace vehicles, ground vehicles, or stationary applications for which oxygen and/or air has to be supplied to the fuel cell system.

### CROSS REFERENCE TO RELATED APPLICATIONS

This application claims the benefit of U.S. Provisional Application Ser. No. 61/620,517, filed Apr. 5, 2013, titled “Oxygen/Air Supply For Fuel Cell Applications,” the entire contents of which are hereby incorporated by reference.

### FIELD OF THE INVENTION

Embodiments of the present invention relate generally to oxygen/air supply systems and methods for use with fuel cell system applications on-board passenger transportation vehicles, such as aircraft or other aerospace vehicles, ground vehicles, or stationary applications for which oxygen and/or air has to be supplied to the fuel cell system.

### BACKGROUND

Current fuel cell systems are generally fed with pure oxygen (100% of O₂) or air (˜21% of O₂). The fuel cell system efficiency depends on the Membrane Electrode Assembly (polarization curve) and cathode supply fluids (Oxygen or air). A fuel cell stack device converts chemical energy from a fuel into electricity through an electrochemical reaction with an oxidizer (oxygen). It is common to use the oxygen contained in air (˜21%) or other oxygen sources. As fuel, Hydrogen is used in most of the common fuel cell systems.

Fuel cells differ from batteries in that they require a supply of fuel and oxidant to operate, but they can produce electricity continuously for as long as these inputs are supplied. The energy efficiency of a fuel cell to produce electricity is typically between 50-70%. Additionally, the higher the concentration of oxygen (oxygen >21%), the better the fuel cell efficiency is. Fuel cell systems are not always optimized between the storage Weight/Volume ratio and the % O₂/FCS (fuel cell system) efficiency ratio. A tradeoff must thus be performed between these ratios depending on the fuel cell and its field of application.

In the aerospace field, the current power generation options (ground power unit, auxiliary power unit, and engines) produce noise and CO₂ emissions as their by-products, and require fossil fuels for operation. By contrast, fuel cell systems produce water and nitrogen (Oxygen Depleted Air) as their by-products.

A number of components on-board an aircraft require electrical power for their activation. Many of these components are separate from the electrical components that are actually required to run the aircraft (i.e., the navigation system, fuel gauges, flight controls, and hydraulic systems). For example, aircraft also have catering equipment, heating/cooling systems, lavatories, power seats, water heaters, and other components that require power as well. Specific components that may require external power include but are not limited to trash compactors (in galley and/or lavatory), ovens and warming compartments (e.g., steam ovens, convection ovens, bun warmers), optional dish washer, freezer, refrigerator, coffee and espresso makers, water heaters (for tea), air chillers and chilled compartments, galley waste disposal, heated or cooled bar carts/trolleys, surface cleaning, area heaters, cabin ventilation, independent ventilation, area or spot lights (e.g., cabin lights and/or reading lights for passenger seats), water supply, water line heating to prevent freezing, charging stations for passenger electronics, electrical sockets, vacuum generators, vacuum toilet assemblies, grey water interface valves, power seats (e.g., especially for business or first class seats), passenger entertainment units, emergency lighting, and combinations thereof. These components are important for passenger comfort and satisfaction, and many components are absolute necessities.

However, one concern with these components is their energy consumption. As discussed, galley systems for heating and cooling are among several other systems aboard the craft which simultaneously require power. Frequently, such systems require more power than can be drawn from the aircraft engines' drive generators, necessitating additional power sources, such as a kerosene-burning auxiliary power unit (APU) (or by a ground power unit if the aircraft is not yet in flight). This power consumption can be rather large, particularly for long flights with hundreds of passengers. Additionally, use of aircraft power produces noise and CO₂ emissions, both of which are desirably reduced. Accordingly, it is desirable to identify ways to improve fuel efficiency and power management by providing innovative ways to power these components. There are new ways being developed to generate power to run on-board components, as well as to harness beneficial by-products of that power generation for other uses on-board passenger transport vehicles, such as aircraft.

The relatively new technology of fuel cells provides a promising cleaner and quieter means to supplement energy sources already aboard aircrafts. A fuel cell has several outputs in addition to electrical power, and it is beneficial to utilize these outputs as well. Fuel cell systems combine a fuel source of compressed hydrogen with oxygen in the air to produce electrical and thermal power as a main product. Water and Oxygen Depleted Air (ODA) are produced as by-products, which are far less harmful than CO₂ emissions from current aircraft power generation processes.

### BRIEF SUMMARY

Embodiments of the invention described herein thus provide an autonomous Fuel Cell System with an optimized efficiency to weight and volume ratio by virtue of its having an innovative cathode supply system generating air, Oxygen Enriched Air, or pure oxygen (O₂).

### BRIEF DESCRIPTION OF THE DRAWINGS

FIG. 1 illustrates a schematic of one embodiment of an oxygen/air supply for a fuel cell system using an on-board oxygen generation system.

FIG. 2 illustrates a schematic of a further embodiment of the oxygen/air supply of FIG. 1.

FIG. 3 illustrates a schematic of one embodiment of an oxygen/air supply for a fuel cell system using an on-board inerting gas generation system.

FIG. 4 illustrates a schematic of one embodiment of an oxygen/air supply for a fuel cell system using a chemical oxygen generator.

FIG. 5 illustrates a schematic of an embodiment of an oxygen/air supply for a fuel cell system using a chemical oxygen generator that mixes air with a venturi.

FIG. 6 illustrates a schematic of an alternate embodiment of a chemical oxygen generator/venturi system.

FIG. 7 illustrates a schematic of a fuel cell system with natural flow from a pressurized to an unpressurized area.

FIG. 8 illustrates a schematic of an alternate embodiment of an oxygen/air supply for a fuel cell system using an on-board oxygen generation system with a valve that allows air to be routed to passenger masks or to a fuel cell system, depending upon the greater need.

### DETAILED DESCRIPTION

The embodiments described herein are useful with any types of fuel cell systems, including but not limited to PEMFC or PEM (Proton Exchange Membrane), SOFC (Solid Oxide), MCFC (Molten Carbonate), DMFC (Direct Methanol), AFC (Alkaline), PAFC (Phosphoric Acid) and any new fuel cell system technology comprising hybrid solutions. Although they are described with particular emphasis for use on aircraft and other aerospsace vehicles, the systems and methods described herein may be useful on other passenger transport vehicles, as well as other fuel cell systems that are stationary.

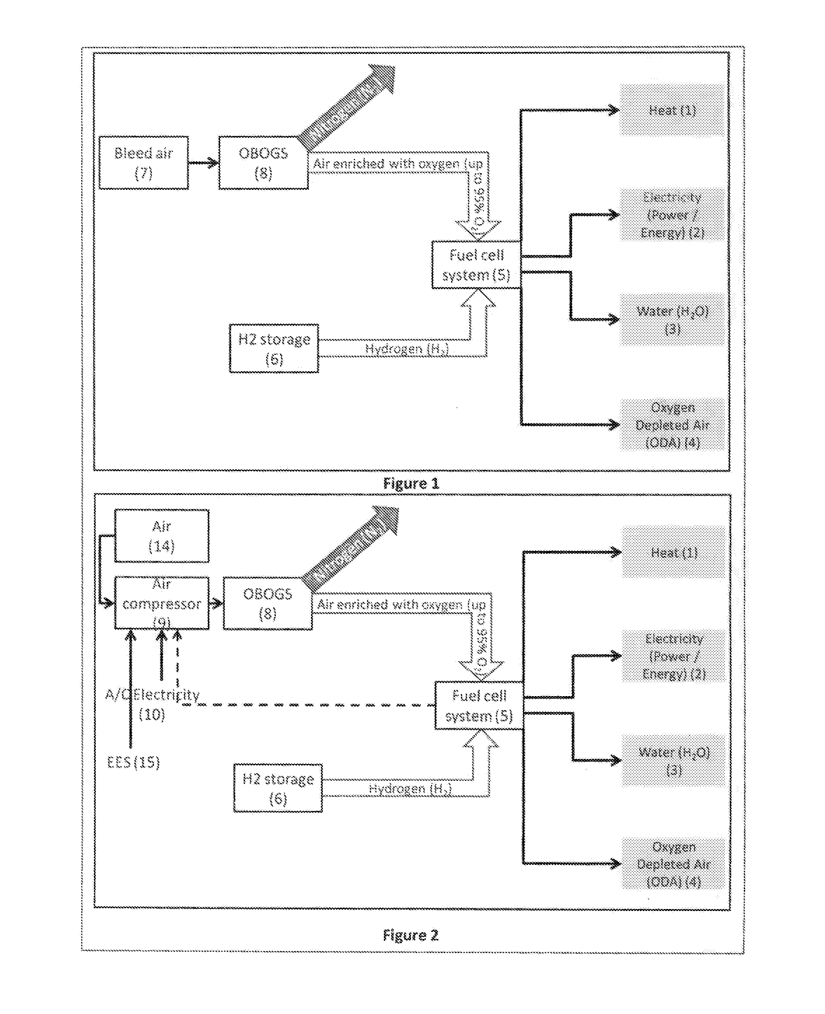

As discussed above and as shown in the schematic FIGS. 1-8, the by-products of a fuel cell system 5 are heat 1 generated by the fuel cell operation, electricity (power/energy) 2 generated by the fuel cell system, water (H₂O) 3, and Oxygen Depleted Air (ODA) 4 (when supplied with by non-pure oxygen). The fuel cell system 5 and its ancillaries includes a Hydrogen (H₂) source, which is typically housed in a hydrogen storage unit 6. The H₂ may be stored in pressurized tanks that can be refilled by various different methods (e.g., liquid, reforming, solid storage, or any other appropriate method). The system fuel cell 5 also needs an input of oxygen and/or air from an air and/or oxygen source in order to create electricity and its other by-products. Embodiments of this invention thus relate to various options that provide efficient and consistent delivery of oxygen and/or air to the fuel cell system 5 for its operation.

In the embodiment illustrated in FIG. 1, the air/oxygen source for the fuel cell system 5 on-board a passenger aircraft is bleed air 7, which is air generated by the aircraft engines. The bleed air 7 is supplied to the On Board Oxygen Generations System (OBOGS) 8. The OBOGS generates oxygen (up to 95% of O₂) as the main product and a mixture of Oxygen/Nitrogen as by-product. The OBOGS supplies the fuel cell system 5 with Oxygen Enriched Air (OEA) generated from the OBOGS 8 using the bleed air 7.

Additionally or alternatively, in the embodiment illustrated by FIG. 2, the initial air/oxygen source/generation may be provided by an air compressor 9. The air compressor 9 acts as a device for pressurizing incoming air 14 for fuel cell system 5 operation. The incoming air 14 may be provided by any appropriate source, such as the aircraft ECS (environmental control system), bleed air, pressurized and/or unpressurized air, external air, cabin air, cargo air, or any other appropriate source. A/C electricity 10 is supplied to the air compressor, which is used to supply air to the OBOGS 8, which then provides the fuel cell system 5 with Oxygen Enriched Air. Once the fuel cell system 5 has been activated and is operating, the electricity for the air compressor 9 may then be supplied by the electricity 2 generated by the fuel cell system 5, as shown by the feedback loop in dotted lines in FIG. 2. However, if an autonomous start-up of the air compressor 9 is desired, the Electric Energy Storage (EES) 15 could be used.

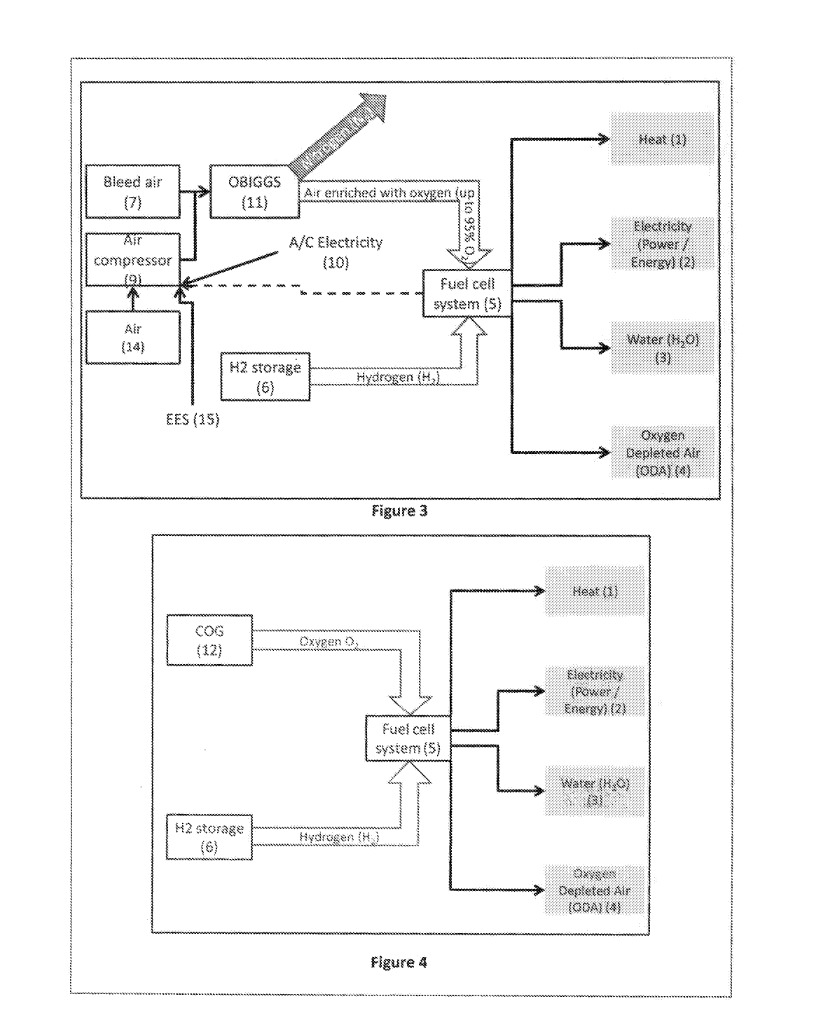

FIG. 3 illustrates an alternate embodiment that uses the On Board Inerting Gas Generation System (OBIGGS) 11 to supply the air to the system 5. The OBIGGS generates inerting gas for use in various applications on-board the aircraft, particularly to maintain a chemically non-reactive or “inert” gas, such as nitrogen in a combustible or flammable space, such as a fuel tank. In this embodiment, the OBIGGS may pull pressurized air from either the bleed air 7 and/or an air compressor 9, and generates air enriched with oxygen for delivery to the fuel cell system 5. The OBIGGS is generally used to generate inerting gas, such as nitrogen N_{2,} as the main product (which can be used by tank inerting system and/or any other aircraft application), and only generates Oxygen Enriched Air (OEA) as a by-product. However, the present inventors have determined that harnessing that OEA may allow it to be used as the main product—for oxygen delivery to the fuel cell system 5.

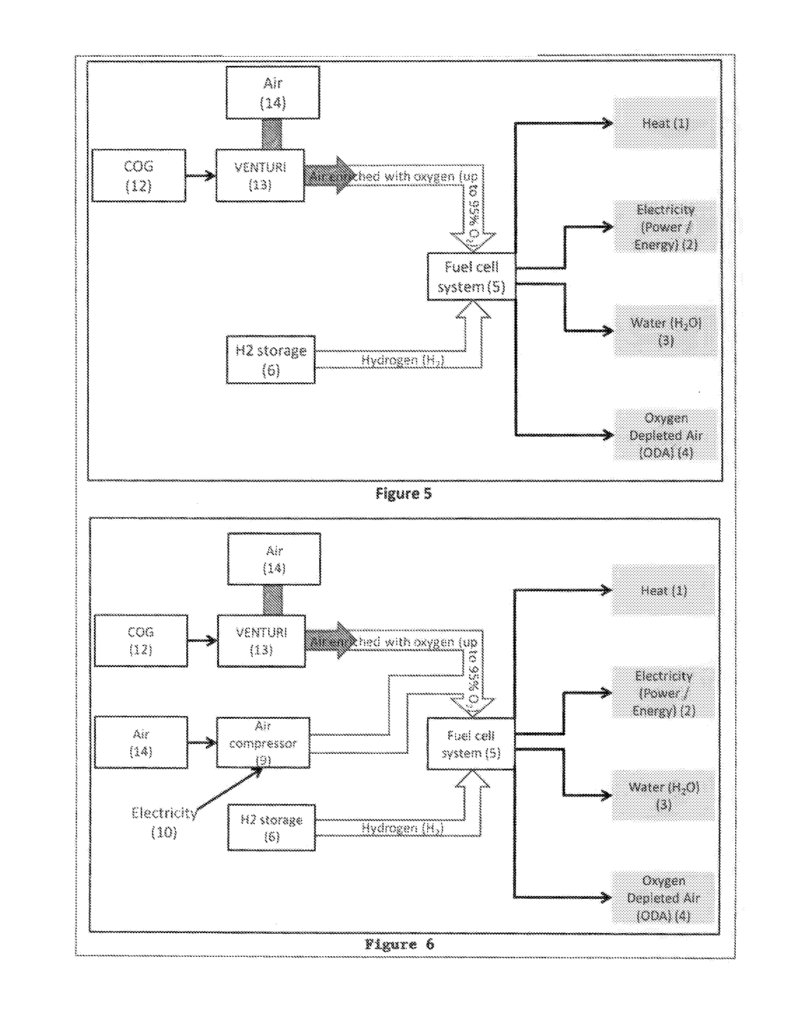

A further embodiment, illustrated by FIG. 4, uses a Chemical Oxygen Generator COG (12) for providing the oxygen to the system 5. The COG is generally used for passenger oxygen in case of aircraft depressurization. In this embodiment, the COG 12 supplies pure oxygen (100%) to the fuel cell system 5. FIG. 5 shows the use of a venturi 13, which allows pure oxygen from the COG 12 to be mixed with air 14, giving OEA as a by-product for delivery to the fuel cell system. The air 14 may come from a pressurized or unpressurized area on-board the aircraft or from outside the aircraft. The COG 12 provides an oxygen pressurized flow at a high speed in order to draw ambient air 14 through a venturi 13 and pressurize it to supply the fuel cell system 5.

FIG. 6 illustrates a combination system that provides Oxygen Enriched Air (from the COG 12 and venturi 13 system described above) and/or via an air compressor 9. In addition to the concepts described in connection with FIG. 5, ambient air 14 may be pressurized by an air compressor 9 (or any air supply, for instance bleed air 7 or independent air from the compressor 9). As discussed above, in the event of an air compressor source failure or for the initial start-up, the COG 12 may provide a pressurized flow at a high speed in order to draw ambient air 14 through a Venturi 13 and pressurize it to supply the fuel cell system 5.

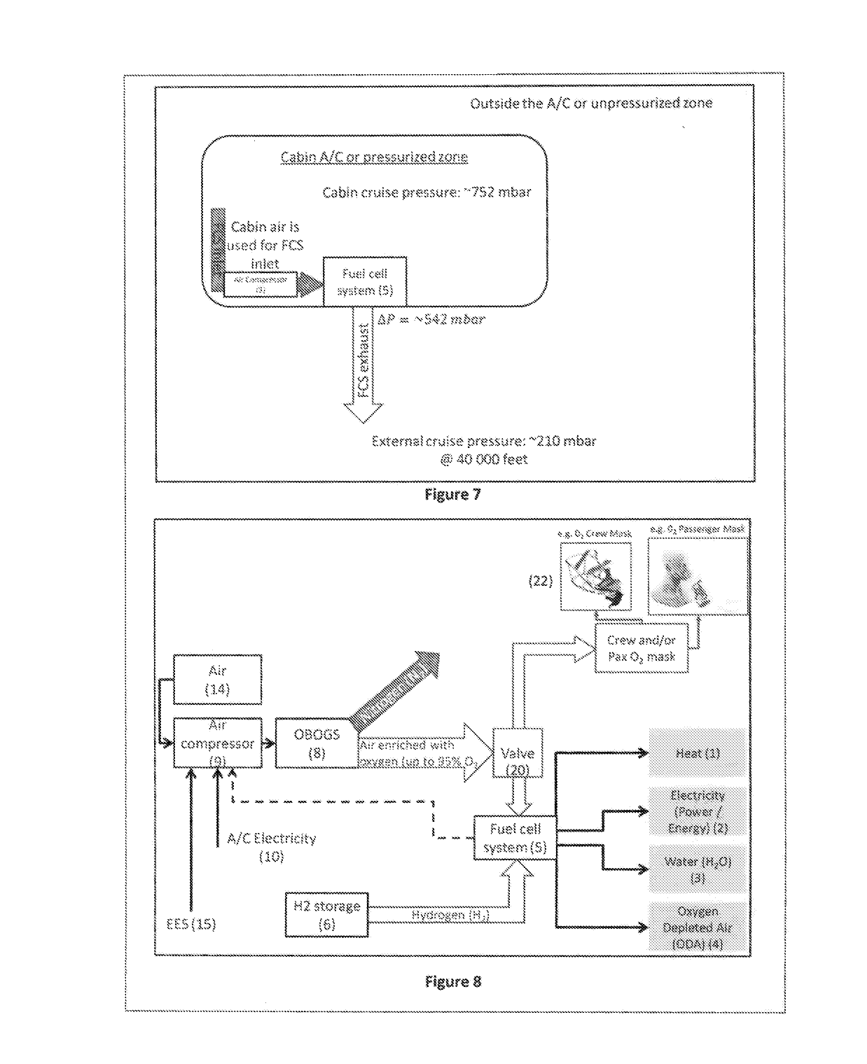

FIG. 7 illustrates a fuel cell system with a natural flow (from a pressurized and unpressurized area). There is a natural air circulation inside the cathode fuel cell during cabin cruise pressure. The air compressor 9 may be switched on when the difference in pressure between a pressurized and unpressurized area is not sufficient to ensure necessary air flow to operate the fuel cell system 5.

FIG. 8 illustrates an embodiment which provides a supply of Oxygen Enriched Air for the fuel cell system 5, as well as the crew and/or passengers' oxygen mask. In this embodiment, the OBOGS 8 can provide oxygen enriched air to the fuel cell system 5 when oxygen is not used for crew and/or passengers oxygen mask. The selection is controlled by a valve 20. When the OBOGS 8 is not being used in an emergency condition to deliver oxygen to breathing masks 22, the valve 20 may be switched to allow the OBOGS 8 to deliver oxygen to the fuel cell system 5. In addition, the valve 20 can supply its product to oxygen masks and the fuel cell system as an option. (There may be additional safety checks involved in this embodiment order to address and comply with various safety concerns.)

It should be understood that each of the systems and embodiments shown and described may be used alone or in combination with any of the other described embodiments. The primary goal is to provide an optimized way to provide and deliver air/oxygen to the fuel cell system 5 with the desired weight and volume ratio. This provides an autonomous fuel cell system that has a hydrogen source as well as an oxygen enriched air or pure oxygen source.

Changes and modifications, additions and deletions may be made to the structures and methods recited above and shown in the drawings without departing from the scope or spirit of the invention and the following claims.

What is claimed is:

1. An oxygen/air source for a fuel cell system positioned on-board an aircraft, comprising an on-board oxygen generation system configured to receive bleed air from aircraft engines or air from an air compressor in order to generate air enriched with oxygen for delivery to the fuel cell system.

2. The oxygen/air source of claim 1, wherein the air compressor is initially started using an alternate electricity source but once started, uses electricity from the fuel cell system for operation.

3. The oxygen/air source of claim 1, wherein the air is enriched with oxygen up to 95% O₂.

4. The oxygen/air source of claim 1, further comprising a valve configured to deliver the air enriched with oxygen to breathing masks if required in the event of an emergency but that can be activated to re-route the air enriched with oxygen to the fuel cell system in non-emergency conditions.

5. An oxygen/air source for a fuel cell system positioned on-board an aircraft, comprising an on-board inerting gas generation system configured to receive bleed air from aircraft engines or air from an air compressor in order to generate air enriched with oxygen for delivery to the fuel cell system.

6. An oxygen/air source for a fuel cell system positioned on-board an aircraft, comprising a chemical oxygen generator configured to deliver pure oxygen through a venturi, wherein the pure oxygen is combined with an incoming air source in order to generate air enriched with oxygen for delivery to the fuel cell system.

7. The oxygen/air source of claim 6, wherein the air from the incoming air source comprises air from an air compressor, air from the aircraft ECS (environmental control system), bleed air, pressurized and/or unpressurized air, external air, cabin air, or cargo air.

8. An oxygen/air source for a fuel cell system positioned on-board an aircraft comprising a pressurized zone and wherein there is an unpressurized area outside the aircraft, the system comprising a fuel cell on board the aircraft and an air compressor, wherein the air compressor is switched on when the difference in pressure between the pressurized zone and the unpressurized area outside the aircraft is not sufficient to ensure necessary air flow to operate the fuel cell system.
